(19) United States
(12) Patent Application Publication
(10) Pub. No.: US 2016/0288639 A1
(43) Pub. Date: Oct. 6, 2016

(54) STRUCTURE FOR MOUNTING DIESEL OXIDATION CATALYST DEVICE TO GENERATOR MOTOR

(71) Applicant: KOMATSU LTD., Tokyo (JP)

(72) Inventors: Yuusuke Kikuchi, Hiratsuka-shi (JP); Masaki Yamanaka, Hiratsuka-shi (JP); Takashi Sugiguchi, Neyagawa-shi (JP)

(73) Assignee: KOMATSU LTD., Tokyo (JP)

(21) Appl. No.: 14/353,369

(22) PCT Filed: Nov. 19, 2013
(86) PCT No.: PCT/JP2013/081214

§ 371 Date: Apr. 22, 2014

(30) Foreign Application Priority Data
Mar. 29, 2013 (JP) 2013-074774

(51) Int. Cl. B60K 13/04; B60K 1/00; F01N 3/10

(52) U.S. Cl. CPC B60K 13/04; F01N 3/103; B60K 1/00

(57) ABSTRACT

A structure for mounting a diesel oxidation catalyst device to a generator motor includes: a generator motor arranged between an engine and a hydraulic pump; a diesel oxidation catalyst device mounted on an upper part of the generator motor; and a bracket provided between the generator motor and the diesel oxidation catalyst device and adapted to separately arrange the diesel oxidation catalyst device above the generator motor, wherein a boss with screw hole erecting upward is formed on an upper part of a generator motor housing, and a lower part of the bracket is fastened to the boss with screw hole with a bolt.

### FIELD

The present invention relates to a structure for mounting a diesel oxidation catalyst (DOC) device to a generator motor in a case where the diesel oxidation catalyst device is mounted on an upper part of the generator motor arranged between an engine and a hydraulic pump.

### BACKGROUND

In recent years, a hybrid-type construction machine in which a generator motor is mounted between an engine and a hydraulic pump has been developed. The generator motor is connected to an output shaft of the engine and an input shaft of the hydraulic pump, and generates power by driving force of the engine. The electric energy generated by the generator motor is stored in a storage device such as a capacitor. When the construction machine needs a high engine output, the generator motor is driven by the electric energy stored in the storage device, and assists the engine output.

Here, in Patent Literature 1, a muffler is arranged on an upper part of a generator motor via a muffler mounting part. The muffler is fixed on the muffler mounting part by a wire wound around an outer peripheral surface thereof.

### CITATION LIST

### Patent Literature

Patent Literature 1: Japanese Patent Laid-open No. 2012-211469

### SUMMARY

### Technical Problem

As described above, the conventional muffler mounting structure provided on an upper part of a generator motor is installed via a muffler mounting part (bracket). The bracket is fastened to a screw hole provided in an upper part of a generator motor housing with a bolt together.

Here, when a DOC device is mounted on the upper part of the generator motor housing in place of the muffler, the DCC device has about twice the weight of the muffler, and has a high temperature of about 400 to 500° C. Due to the increase in the weight of the DOC device, it is necessary to increase installation strength of the bracket that supports and mounts the DOC device to the upper part of the generator motor housing. Due to the increase in the installation strength, it is necessary to increase a bolt diameter and a screw hole diameter. Meanwhile, to prevent an increase in the temperature of a coil of the generator motor, the generator motor cools a cooling oil in an oil reservoir provided at a lower part of the generator motor housing and circulates the cooling oil through a cooling oil intake port in an upper part of the generator motor housing into the generator motor housing. Therefore, if the bolt diameter and the screw hole diameter are made larger, a cooling oil passage including the cooling oil. intake port in the upper part of the generator motor housing and the screw hole interfere with each other. Therefore, the bolt diameter and the screw hole diameter cannot be increased, and it is difficult to increase the installation strength of the bracket.

In addition, since the DOC device is a high-temperature device as described above, it is necessary to separate the DOC device from the generator motor. This is because, if the DOC device is not separated from the generator motor, an increase in the temperature of the generator motor is accelerated, and the temperature of the coil or the generator motor is increased. In order to prevent the increase in the temperature of the coil of the generator motor, increasing a cooling function by the cooling oil without separating the DOC device from the generator motor can be considered. However, if the cooling function is increased, the structure of the generator motor itself becomes larger due to an increase in the size of a cooling function unit. When the DOC device is separated from the generator motor, it is necessary to further increase the strength of the bracket itself and the installation strength of the bracket to the upper part of the generator motor housing.

The invention has been made in view of the foregoing, and an objective is to provide, when a DOC device is mounted on an upper part of a generator motor housing is a bracket, a structure for mounting a diesel oxidation catalyst device to a generator motor, which is capable of increasing the installation strength of the bracket, which mounts the DOC device having a large weight, to the upper part of the generator motor housing without having an impact on a cooling function of the generator motor.

### Solution to Problem

To solve the problem described above and achieve the object, a structure for mounting a diesel oxidation catalyst device to a generator motor according to the present invention includes: a generator motor arranged between an engine and a hydraulic pump; a diesel oxidation catalyst device mounted on an upper part of the generator motor; and a bracket provided between the generator motor and the diesel oxidation catalyst device and adapted to separately arrange the diesel oxidation catalyst device above the generator motor, wherein a boss with screw hole erecting upward is formed on an upper part of a generator motor housing, and a lower part of the bracket is fastened to the boss with screw hole with a bolt.

Moreover, in the structure for mounting a diesel oxidation catalyst device to a generator motor according to the above-described invention, a cooling oil passage including a cooling oil intake port is formed in a base of the boss with screw hole, and a screw hole of the boss with screw hole does not interfere with the cooling oil passage.

Moreover, the structure for mounting a diesel oxidation catalyst device to a generator motor according to the above-described invention further includes a partition bracket installed to an upper side part of the generator motor housing at a side of the hydraulic pump and a lower part of the bracket at the side of the hydraulic pump and adapted to function as a partition to separate the side of the hydraulic pump and a side of the engine.

Moreover, the structure for mounting a diesel oxidation catalyst device to a generator motor according to the above-described invention further includes a pipe support bracket installed to the bracket and adapted to support an exhaust intake pipe of the diesel oxidation catalyst device.

Moreover, in the structure for mounting a diesel oxidation catalyst device to a generator motor according to the above-described invention, a part of the exhaust intake pipe uses bellows pipe.

Moreover, in the structure for mounting a diesel oxidation catalyst device to a generator motor according to the above-described invention the partition bracket is fastened to a cylindrical pipe with screw hole provided at an upper outer periphery of the generator motor housing with a bolt from a side of the generator motor housing and is fastened to a bottom plate of the bracket with a bolt.

Moreover, a structure for mounting a diesel oxidation catalyst device to a generator motor according to the present invention includes: a generator motor arranged between an engine and a hydraulic pump; a diesel oxidation catalyst device mounted on an upper part of the generator motor; a bracket provided between the generator motor and the diesel oxidation catalyst device, and adapted to separately arrange the diesel oxidation catalyst device above the generator motor; and a partition bracket installed to an upper side part of a generator motor housing at a side of the hydraulic pump and a lower part of the bracket at the side of the hydraulic pump and adapted to function as a partition to separate the side of the hydraulic pump and a side of the engine, wherein a boss with screw hole erecting upward is formed on an upper part of the generator motor housing, a lower part of the bracket is fastened to the boss with screw hole with a bolt, a cooling oil passage including a cooling oil intake port is formed in a base of the boss with screw hole, and a screw hole of the boss with screw hole does not interfere with the cooling oil passage, and the partition bracket is fastened to a cylindrical pipe with screw hole provided at an upper outer periphery of the generator motor housing with a bolt from a side of the generator motor housing and is fastened to a bottom plate of the bracket with a bolt.

According to the invention, a diesel oxidation catalyst device is separately arranged above a generator motor with a bracket, a boss with screw hole erecting upward is formed on an upper part of a generator motor housing, and a lower part of the bracket is fastened to the boss with screw hole with a bolt. Therefore, the installation strength of the bracket that mounts a DOC device having a large weight to an upper part of the generator motor housing can be increased without having an impact on the cooling function of the generator motor.

### BRIEF DESCRIPTION OF DRAWINGS

FIG. 1 is a perspective view illustrating an overall structure of a hybrid excavator that is an example of a working machine in which an engine unit having a structure for mounting a diesel oxidation catalyst device to a generator motor according to an embodiment of the invention is mounted.

FIG. 2 is a perspective view of the engine unit.

FIG. 3 is a front view of the engine unit.

FIG. 4 is a left side view of the engine unit.

FIG. 5 is a plan view of the engine unit.

FIG. 6 is an exploded perspective view of a DOC device mounting structure as viewed from a side of a hydraulic pump.

FIG. 7 is an exploded perspective view of the DOC device mounting structure as viewed from a side of the engine.

FIG. 8 is a left side view of an upper part of a generator motor housing illustrating a positional relationship between a screw hole of a boss with screw hole and a cooling oil passage.

### DESCRIPTION OF EMBODIMENTS

Hereinafter, embodiments for implementing the invention will be described with reference to the appended drawings.

### [Hybrid Excavator]

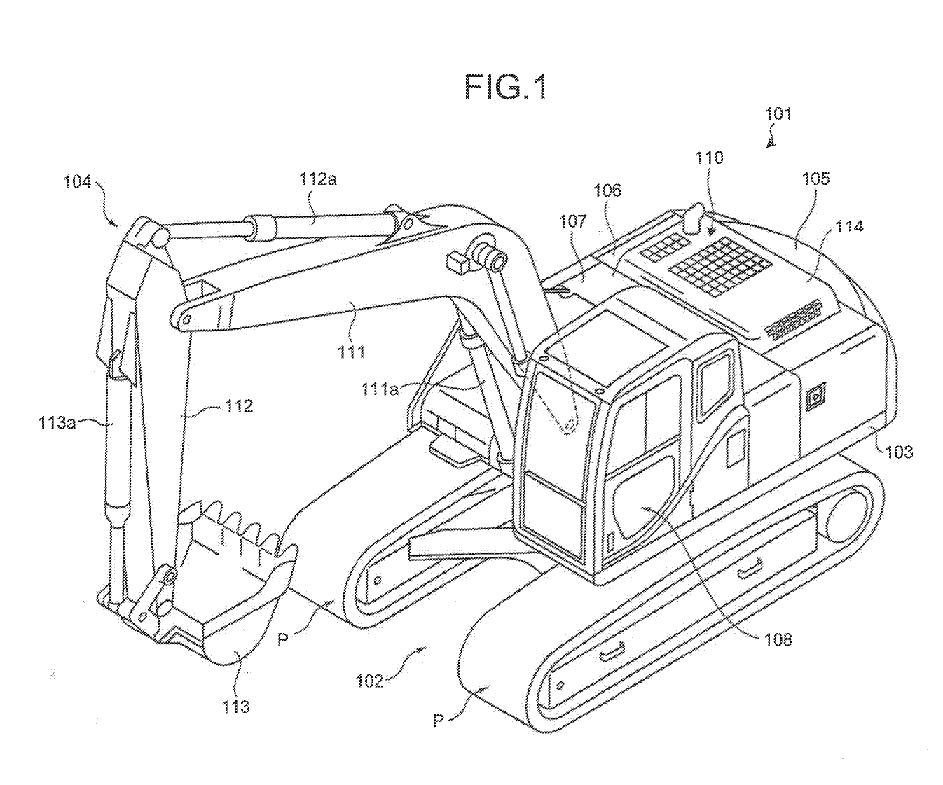

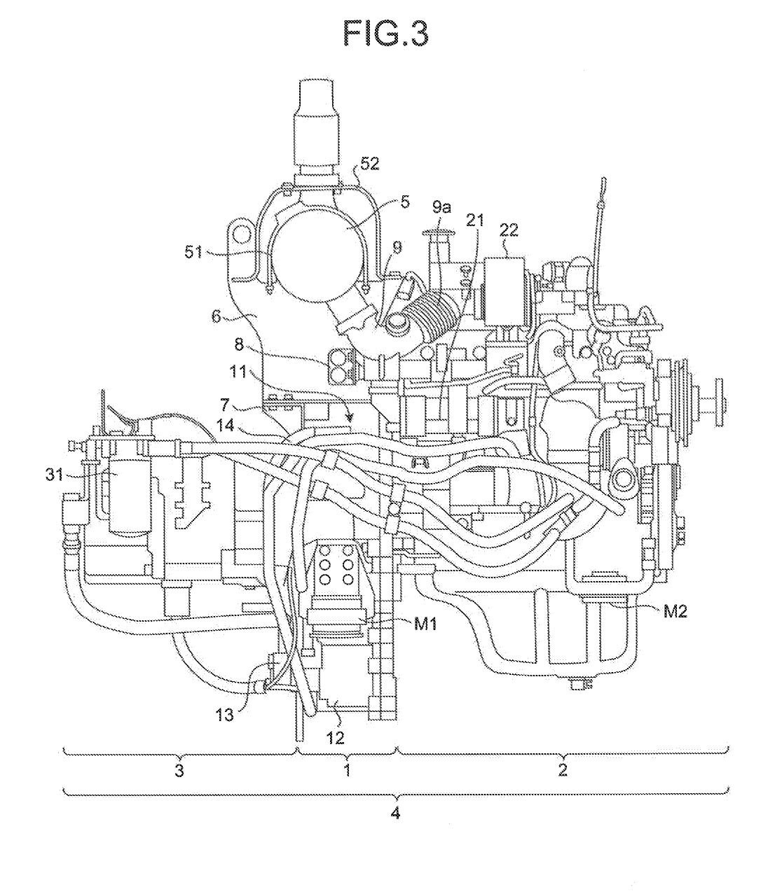

First, FIG. 1 is a perspective view illustrating an overall structure of a hybrid excavator 101 that is an example of a working machine in which an engine unit having a structure for mounting a diesel oxidation catalyst device to a generator motor according to an embodiment of the invention is mounted. The hybrid excavator 101 includes a lower traveling body 102, a swing table 103, an operation machine 104, a counterweight 105, a machine room 106, a vehicle body 107, and a cab 108. The hybrid excavator 101 is provided with an engine 2 as a driving power source. A generator motor 1 driven by the engine 2 and the hydraulic pump 3 are connected to an output shaft of the engine 2 in series (see FIG. 3).

The lower traveling body 102 moves the hybrid excavator 101 forward or backward by rotating crawler belts P wound around both of right and left end portions in a traveling direction. The swing table 103 is mounted on an upper surface of the lower traveling body 102. The swing table 103 can swing in an arbitrary direction with respect to the lower traveling body 102. The operation machine 104, the counterweight 105, the machine room 106, the vehicle body 107, and the cab 108 are mounted on an upper surface of the swing table 103. Further, the swing table 103 swings by a swinging electric motor driven by power supply from the generator motor 1 or a storage battery. The swinging electric motor generates power by regeneration at deceleration of a swinging operation of the swing table 103. The electric energy obtained by the power generation is stored in the capacitor.

The operation machine 104 includes a boom 111, an arm 112 attached to a distal end of the boom 111, and a bucket 113 attached to a distal end of the arm 112. The operation machine 104 operates the boom 111, the arm 112, the bucket 113, and the like by driving hydraulic cylinders 111a, 112a, 113a, and the like included in a hydraulic circuit (not illustrated) by pressure oil discharged by a hydraulic pump 3. The hybrid excavator 101 performs excavating work, and the like by operating the boom 111, the arm 112, the bucket 113, and the like.

The counterweight 105 is formed of scrap iron, concrete, or the like filled and hardened in a box made of assembly of steel plates, for example. The counterweight 105 is provided in the rear side of the swing table 103 in order to balance a vehicle body at the excavating work, and the like.

The machine room 106 is arranged at a position adjacent to the counterweight 105. The machine room 106 includes therein an engine room 110 that accommodates an engine unit 4 that is integration of the engine 2, the generator motor 1 and the hydraulic pump 3 in an axis direction, and the like, as illustrated in FIG. 3. The engine room 110 is covered with an openable/closable engine hood 114. The machine room 106 has a space surrounded by an operating oil tank (not illustrated), a partitioning member provided between the engine room 110 and the cab 108, opening/closing covers provided at right and left rear side surfaces of the vehicle, the counterweight 105, the engine hood 114, and the like. The engine 2, the generator motor 1, and the hydraulic pump 3 are arranged side by side along the counterweight 105 in the machine room 106.

The vehicle body 107 is arranged posterior to the operation machine 104. The vehicle body 107 accommodates a fuel tank, an operating oil tank, and an operation valve (not illustrated).

The cab 108 includes an interior space in which an operator of the hybrid excavator 101 moves up and down. The cab 108 is arranged at a front left side part that is a side of the operation machine 104 arranged on the swing table 103 so that a distal end portion of the operation machine 104 can be seen.

### [Engine Unit]

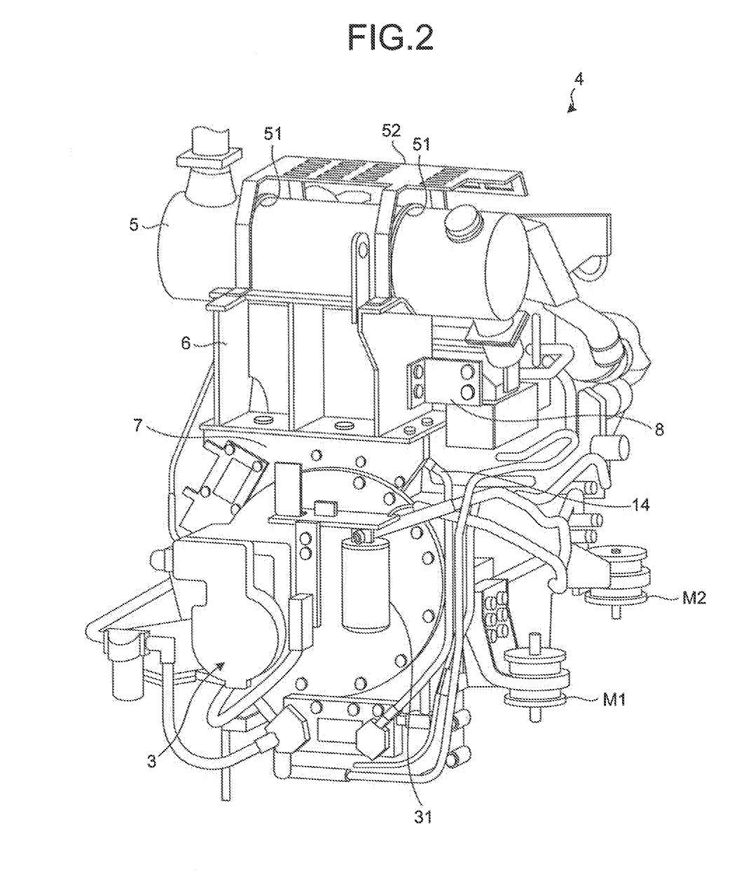

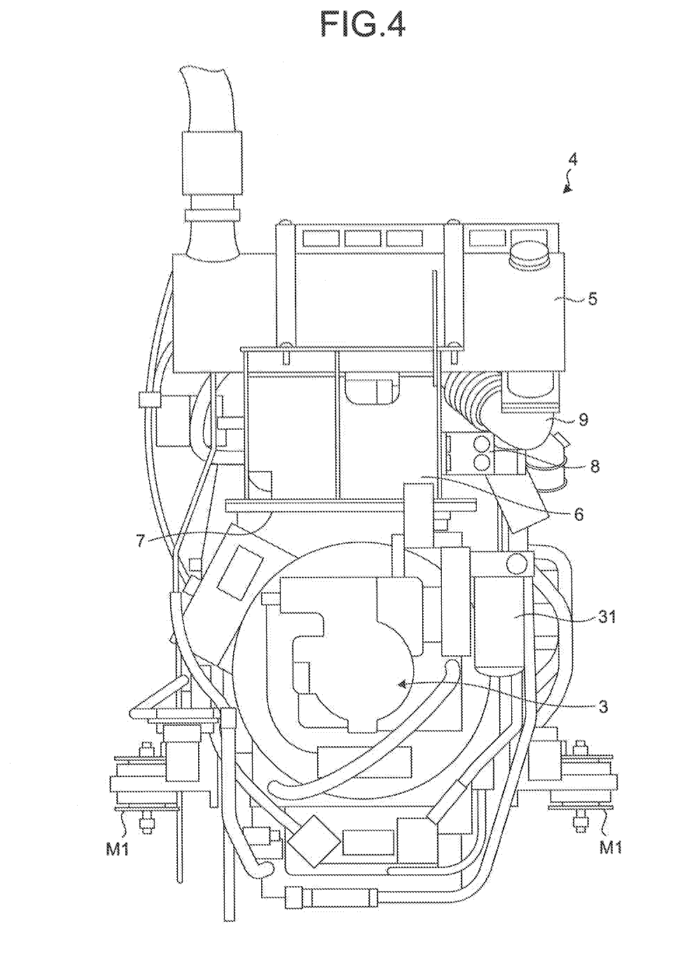

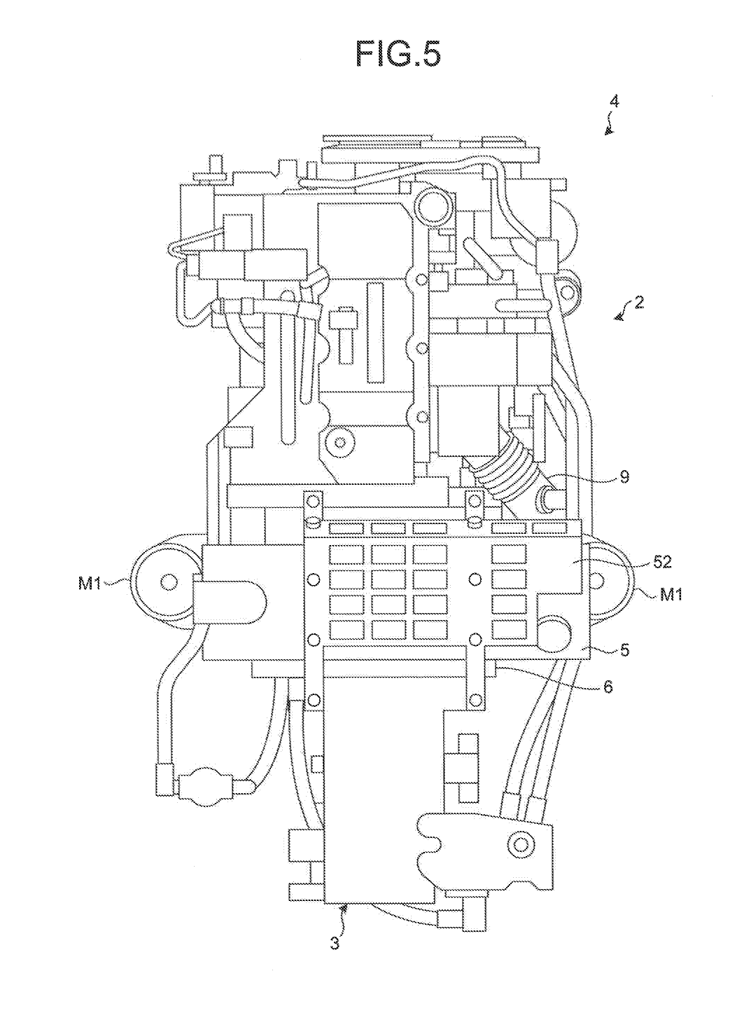

FIG. 2 is a perspective view of the engine unit 4 FIG. 3 is a front view of the engine unit 4. FIG. 4 is a left side view of the engine unit 4. FIG. 5 is a plan view of the engine unit 4. The engine unit 4 is accommodated in the engine room 110, as described above. Hereinafter, description will be given with reference to FIGS. 2 to 5, mainly using FIG. 3. As illustrated in FIG. 3, the engine unit 4 includes the generator motor 1, the engine 2, the hydraulic pump 3, a DOC device 5, and the like. The generator motor 1 is arranged between the engine 2 and the hydraulic pump 3. The generator motor 1 is connected to the output shaft of the engine 2 and an input shaft of the hydraulic pump 3. The DOC device 5 is mounted on the upper part of the generator motor 1 through a bracket 6. The bracket 6 has a function to separately arrange the DOG device 5, which becomes in a high-temperature state, above the generator motor 1. The engine unit 4 is, as illustrated in FIGS. 2, 4, and 5, supported, by a vehicle body frame at four points by mounts M1 provided at right and left sides of the generator motor 1 and mounts M2 provided at right and left sides of the engine 2, and is accommodated in the engine room 110.

### [Generator Motor]

The generator motor 1 is a 3-phase, 12-pole switched reluctance (SR) motor. A rotor is inserted into an inner circumference side of an annular stator in the generator motor 1. A coil is wound around a protrusion of the annular stator, The generator motor 1 is protected by a generator motor housing 11, and the stator is attached to an inner side of the generator motor housing 11.

The generator motor 1 includes an oil reservoir 12 in which a cooling oil for cooling and lubrication is stored in a lower part of the generator motor housing 11. Further, the generator motor 1 includes an oil cooler 13 at a lower part of the generator motor housing 11 and at a side of the hydraulic pump 3. To prevent deterioration of the generator motor 1 due to an increase in the temperature of the coil, the generator motor 1 cools the cooling oil in the oil reservoir 12 with the oil cooler 13, and injects the cooling oil into the generator motor housing 11 from an upper part of the generator motor housing 11 through cooling oil pipe 14.

### [Engine]

The engine 2 is a diesel engine. The engine 2 includes an EGR cooler 21 and a variable turbo supercharger. An exhaust turbine 22 of the variable turbo supercharger and the DOC device 5 are connected through exhaust intake pipe 9. The exhaust intake pipe 9 is a pipe bending downward because the DOC device 5 is separately arranged from the generator motor 1, and has a structure to supply an exhaust as through a lower end part of the DOC device 5 Further, bellows pipe 9a is used for the exhaust intake pipe 9 at a side of the exhaust turbine 22. This is because the distance from the exhaust turbine 22 to the lower end part of the DOC device 5 is long, and thus pipe strength may not be maintained due to vibration. Therefore, by the use of the bellows pipe 9a for a part of the exhaust intake pipe 9, the vibration to the exhaust intake pipe 9 can be more easily absorbed. As a result, vibration resistance of the exhaust intake pipe 9 can be improved.

### [Hydraulic Pump]

The hydraulic pump 3 is a pump of supplying a pressure oil to the operation machine 104, and the like. Further, an oil filter 31 is arranged in the hydraulic pump 3. The oil filter 31 removes contaminants from engine oil used for lubrication of the engine 2.

### [DOC Device]

The DOC device 5 becomes a high temperature of 400 to 500° or more by an action of a coated oxidation catalyst. The DOC device 5 oxidizes an unburned gas in an exhaust has The unburned gas is mainly hydrocarbon HC, carbon monoxide CO, nitrogen oxide NOx, or the like.

As described above, the bracket 6 separately arranges the DOC device 5 above the generator motor 1. The bracket 6 has, at a lower part, a plane fixed to the upper part of the generator motor housing 11. Further, the bracket 6 has, in an upper part, a recessed receiving part that abuts on a side surface of the DOC device 5 having an approximately cylindrical shape, and follows an outer diameter shape of the side surface of the DOC device 5.

The DOC device 5 arranged and abutting on the receiving part is fixed to the bracket 6 with two wires 51, as illustrated in FIG. 2, Further, a protection member 52 is provided at an upper part of the DOC device 5 to cover the DOC device 5. A plurality of through-holes are provided in the protection member 52 in order to improve heat dissipation around the DOC device 5, and the protection member 52 is fixed to an upper part of the bracket 6.

A partition bracket 7 is installed to an upper side part of the generator motor housing 11 at a side of the hydraulic pump 3, and a lower part of the bracket 6 at the side of the hydraulic pump 3, and separates the side of the hydraulic pump 3 and the side of the engine 2. Therefore, the partition bracket 7 has a function to prevent scattering of the oil to high-temperature equipment such as the engine 2, even if an oil system at the hydraulic pump 3 side is defected and the oil is scattered. Further, the partition bracket 7 has a function to widen a narrow width of the upper part of the generator motor housing 11 in a rotation center axis direction and to increase supporting strength of the bracket 6.

A pipe support bracket 8 is provided at a side part of the bracket 6. The pipe support bracket 8 supports the exhaust intake pipe 9. Since the DOC device 5 is separately arranged above the generator motor 1, and thus the exhaust intake pipe 9 is long, the pipe support bracket 8 reinforces the installation strength of the exhaust intake pipe 9.

### [Structure for Mounting DOC Device to Generator Motor]

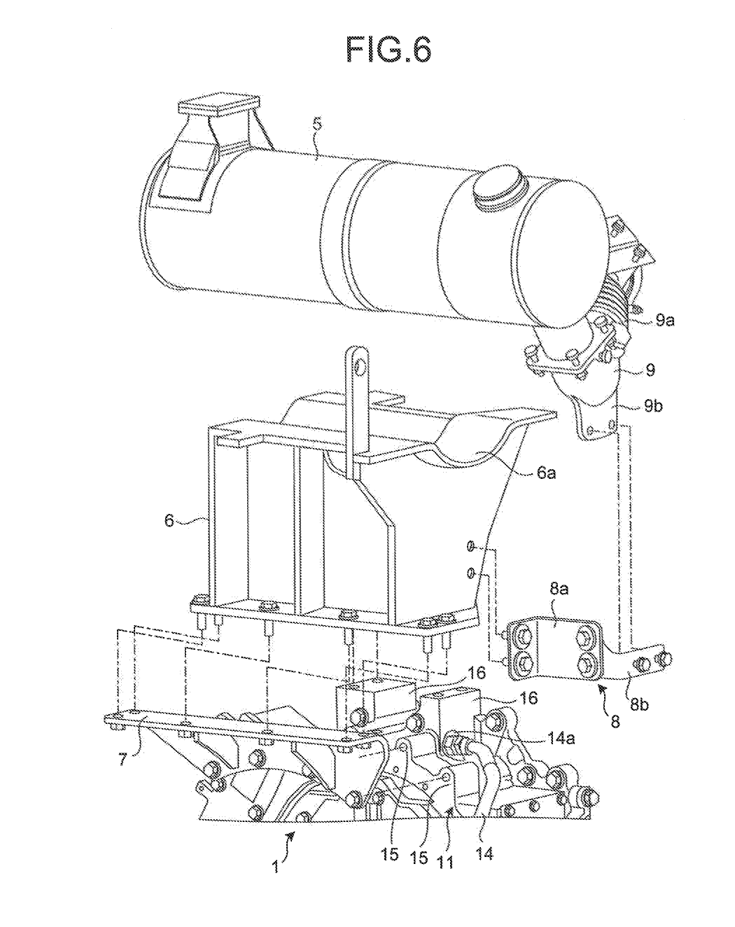

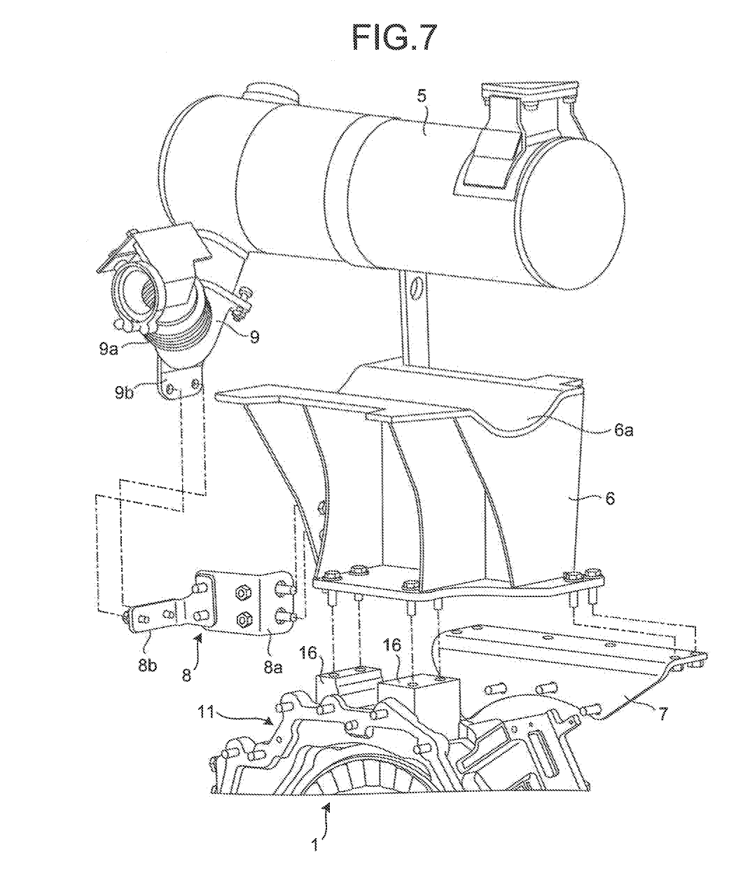

FIG. 6 is an exploded perspective view of the DOC device mounting structure as viewed from the hydraulic pump 3 side. Further, FIG. 7 is an exploded perspective view of the DOC device mounting structure as viewed from the engine 2 side. As illustrated in FIGS. 6 and 7, the partition bracket is installed to the upper side part of the generator motor housing 11 at the hydraulic pump 3 side. Four cylindrical pipes 15 with screw holes are formed in an upper outer periphery of the generator motor housing 11 along the outer periphery at the hydraulic pump 3 side. The partition bracket 7 is fixed by being fastened with four bolts from a side of the generator motor housing 11 toward the four cylindrical pipes 15 with screw holes. The cylindrical pipes 15 with screw holes are used for installing the partition bracket 7 to the generator motor housing 11; therefore, the screw hole diameter and the bolt diameter can be made larger. As a result, the installation strength of the partition bracket 7 to the generator motor housing 11 can be made larger.

Meanwhile, two erecting bosses 16 with screw holes are separately formed at upper parts of the generator motor housing 11 with a predetermined distance. Two screw holes are respectively formed in the bosses 16 with screw holes, and the bosses 16 with screw holes have a total of four screw holes. Fixing of the bracket 6 to the generator motor housing 11 is performed such that a plane of a bottom plate of the bracket 6 abuts on upper end planes formed by the bosses 16 with screw holes, and is fastened to the four screw holes with bolts.

Here, the bosses 16 with screw holes separately erect each other on the upper part of the generator motor housing 11, and therefore, a void is caused between the bosses 16 with screw holes. That is, a space for heat dissipation is made between the bracket 6 and the upper part of the generator motor housing 11, whereby air cooling becomes possible. Therefore, the heat conduction from the high-temperature DOC device 5 mounted on the upper part to the generator motor 1 becomes smaller.

The cross section of the partition bracket 7 has an L shape, and an installation plane is formed at an upper part in a state where the partition bracket 7 is fixed to the generator motor housing 11. The installation plane is the same plane as the upper end planes formed by the bosses 16 with screw holes, and is formed at the hydraulic pump 3 side. Therefore, the installation plane of the bracket 6 becomes larger exceeding the width of the generator motor housing 11 in the rotation center axis direction. As a result, the strength of the bracket 6 itself can be increased. The fixing of the bracket 6 is performed not only by the bolt fastening to the bosses 16 with screw holes but also by bolt fastening to the installation plane of the partition bracket 7 at six positions.

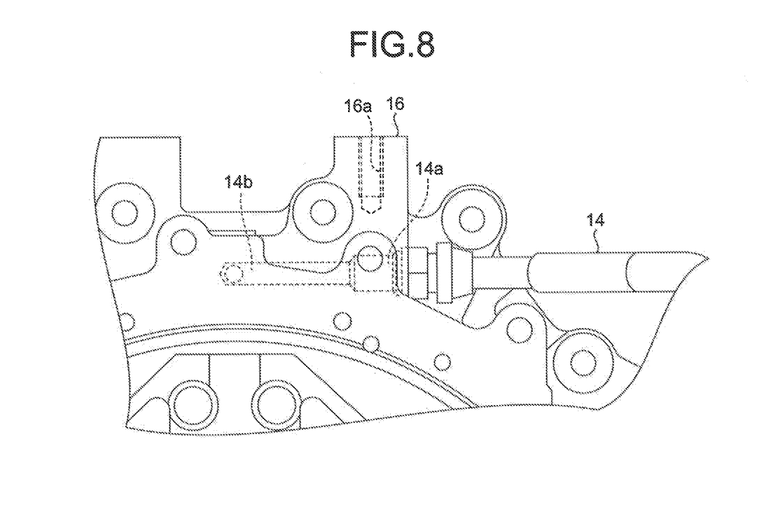

As illustrated in FIG. 8, a cooling oil passage 14b including a cooling oil intake port 14a to which the cooling oil pipe 14 is connected is formed in a base of the boss 16 with screw hole. Here, a screw hole 16a of the boss 16 with screw hole has a depth not to reach the cooling oil passage 14b. Therefore, the screw hole 16a of the boss 16 with screwhole and the cooling oil passage 14b do not interfere with each other. Therefore, the diameter of the screw hole 16a can be made larger, and the installation strength of the bracket 6 to the upper part of the generator motor housing 11 can be made larger. Further, the screw hole 16a of the boss 16 with screw hole and the cooling oil passage 14b are arranged in the vertical direction. Therefore, it is not necessary to widen the width of the generator motor housing 11 in the rotation center axis direction.

The pipe support bracket 8 that supports the exhaust intake pipe 9 is provided at a side part of the bracket 6 and at a side of the exhaust intake pipe 9. The pipe support bracket 8 includes a first bracket 8a arranged at a side of the bracket 6 and a second bracket 8b arranged at the side of the exhaust intake pipe 9. A vertical flange 9b facing downward is provided at the exhaust intake pipe 9. The exhaust intake pipe 9 is fixed to the bracket 6 by the vertical flange 9b being fastened to the second bracket 8b with bolts.

A side surface of a column of the DOC device 5 abuts on a receiving part 6a of the bracket 6. Following that, both end parts of the two wires 51 illustrated in FIGS. 2 and 3 are attached to the bracket 6, so that the DOC device 5 is fixed to the bracket 6.

In the embodiment, the high-temperature DOC device 5 is separately arranged at the upper part of the generator motor 1 via the bracket 6. As a result, the heat conductance of the DOC device 5 to the generator motor 1 can be made smaller, whereby the DCC device 5 does not have an impact on the cooling function of the generator motor 1. In addition, the space formed between the bosses 16 with screw holes can make the heat conductance from the DOC device 5 to the generator motor 1 further smaller.

Further, in the embodiment, the bracket 6 is installed using the bosses 16 with screw holes and the partition bracket 7. Therefore, the installation strength of the bracket 6 can be made larger. Further, the installation area of the bracket 6 becomes larger. Therefore, the strength of the bracket 6 itself can be made larger. As a result, the installation strength of the DOC device 5 having a large weight can be made larger without having en impact on the cooling function of the generator motor 1.

### REFERENCE SIGNS LIST

1 GENERATOR MOTOR

2 ENGINE

3 HYDRAULIC PUMP

4 ENGINE UNIT

5 DOC DEVICE

6 BRACKET

6a RECEIVING PART

7 PARTITION BRACKET

8 PIPE SUPPORT BRACKET

8a FIRST BRACKET

8b SECOND BRACKET

9 EXHAUST INTAKE PIPE

9a BELLOWS PIPE

9b VERTICAL FLANGE

11 GENERATOR MOTOR HOUSING

12 OIL RESERVOIR

13 OIL COOLER

14 COOLING OIL RIPE

14a COOLING OIL INTAKE PORT

14b COOLING OIL PASSAGE

15 CYLINDRICAL PIPE WITH SCREW HOLE

16 BOSS WITH SCREW HOLE

16a SCREW HOLE

21 EGR COOLER

22 EXHAUST TURBINE

31 OIL FILTER

51 WIRE

52 PROTECTION MEMBER

M1 and M2 MOUNT

1. A structure for mounting a diesel oxidation catalyst device to a generator motor, the structure comprising:
a generator motor arranged between an engine and a hydraulic pump;
a diesel oxidation catalyst device mounted on an upper part of the generator motor; and
a bracket provided between the generator motor and the diesel oxidation catalyst device and adapted to separately arrange the diesel oxidation catalyst device above the generator motor,
wherein a boss with screw hole erecting upward is formed on an upper part of a generator motor housing, and
a lower part of the bracket is fastened to the boss with screw hole with a bolt.

2. The structure for mounting a diesel oxidation catalyst device to a generator motor according to claim 1, wherein a cooling oil passage including a cooling oil intake port is formed in a base of the boss with screw hole, and
a screw hole of the boss with screw hole does not interfere with the cooling oil passage.

3. The structure for mounting a diesel oxidation catalyst device to a generator motor according to claim 1, further comprising a partition bracket installed to an upper side part of the generator motor housing at a side of the hydraulic pump and a lower part of the bracket at the side of the hydraulic pump and adapted to function as a partition to separate the side of the hydraulic pump and a side of the engine.

4. The structure for mounting a diesel oxidation catalyst device to a generator motor according to claim 1, further comprising a pipe support bracket installed to the bracket and adapted to support an exhaust intake pipe of the diesel oxidation catalyst device.

5. The structure for mounting a diesel oxidation catalyst device to a generator motor according to claim 4, wherein a part of the exhaust intake pipe uses bellows pipe.

6. The structure for mounting a diesel oxidation catalyst device to a generator motor according to claim 3, wherein the partition bracket is fastened to a cylindrical pipe with screw hole provided at an upper outer periphery of the generator motor housing with a bolt from a side of the generator motor housing and is fastened to a bottom plate of the bracket with a bolt.

7. A structure for mounting a diesel oxidation catalyst device to a generator motor, the structure comprising:
a generator motor arranged between an engine and a hydraulic pump;
a diesel oxidation catalyst device mounted on an upper part of the generator motor;
a bracket provided between the generator motor and the diesel oxidation catalyst device, and adapted to separately arrange the diesel oxidation catalyst device above the generator motor; and
a partition bracket installed to an upper side part of a generator motor housing at a side of the hydraulic pump and a lower part of the bracket at the side of the hydraulic pump and adapted to function as a partition to separate the side of the hydraulic pump and a side of the engine,
wherein a boss with screw hole erecting upward is formed on an upper part of the generator motor housing, a lower part of the bracket is fastened to the boss with screw hole with a bolt, a cooling oil passage including a cooling oil intake port is formed in a base of the boss with screw hole, and a screw hole of the boss with screw hole does not interfere with the cooling oil passage, and
the partition bracket is fastened to a cylindrical pipe with screw hole provided at an upper outer periphery of the generator motor housing with a bolt from a side of the generator motor housing and is fastened to a bottom plate of the bracket with a bolt.
